(19) United States
(12) Patent Application Publication
(10) Pub. No.: US 2023/0183117 A1
(43) Pub. Date: Jun. 15, 2023

(54) WASTEWATER TREATMENT SYSTEM AND METHODOLOGY

(71) Applicant: StreamGo Solutions Inc., Stoney Creek (CA)

(72) Inventors: Justin A. Bonn, Caistor Centre (CA); Richard Nie, Stoney Creek (CA); Kevin Hall, Newmarket (CA); Marco Polverari, Saint-Leonard (CA)

(21) Appl. No.: 18/164,829

(22) Filed: Feb. 6, 2023

Related U.S. Application Data
(63) Continuation-in-part of application No. 17/081,633, filed on Oct. 27, 2020.

(51) Int. Cl. C02F 9/00

(52) U.S. Cl. CPC C02F 9/00; C02F 3/1268

(57) ABSTRACT

A method for treating wastewater includes passing wastewater through a pretreatment component to remove at least portions of one or more contaminants from the wastewater and generate a permeate and passing the permeate through an electro-chemical cell component to remove at least remaining portions of the one or more contaminants and generate an exudate.

### CROSS REFERENCE TO RELATED APPLICATION(S)

The present application is a continuation in-part of Application Serial No. 17/081,633, filed on Oct. 27, 2020, the entire contents of which is incorporated by reference herein.

### BACKGROUND

### Technical Field

The present disclosure relates to a water treatment system and, more particularly, relates to a wastewater treatment system capable of substantially reducing residual contaminants including, for example, phosphorous, in permeate discharged to the environment.

### Description of Related Art

As human and industrial activities increase around the world, the consumption of water results in the creation of wastewater with increasing contaminant levels. Treated effluent is generally discharged through a subsurface tile bed which impacts aquifers used for drinking water or is distributed to a body of surface water which impacts drinking water, aquatic life and vegetation growth. Environmental authorities are responsible to ensure that aquifers and surface waterways do not become overloaded with contaminants. Developments are often restricted to ensure that contaminants do not pollute these water sources rendering them unsuitable for consumption or unsafe to aquatic life. Various commercially available methodologies are employed to remove contaminants from wastewater to meet the contaminant discharge objectives/minimums established by governing bodies. However, these known methodologies are ineffective for their intended applications, expensive and deficient in properly treating the wastewater to remove contaminants, particularly, without limitation, phosphorous or its derivatives, commensurate with environmental standards.

### SUMMARY

Accordingly, the present disclosure is directed to a system and methodology for the reduction of residual contaminants from wastewater within the generated permeate of the treatment system. In illustrative embodiments, the present disclosure is extremely effective in the removal of phosphorous and its derivatives from wastewater permeate or exudate. However, the present invention is not limited to the removal of phosphorous but is suitable for removal of a number of contaminants present in wastewater and water streams.

In one illustrative embodiment, a method for treating wastewater comprises passing wastewater through a pretreatment component to remove at least portions of one or more contaminants from the wastewater and generate a permeate and passing the permeate through an electro-chemical cell component to remove at least remaining portions of the one or more contaminants and generate an exudate. Passing the wastewater through the pretreatment component may comprise passing the wastewater through a membrane bioreactor (MBR) component to produce an MBR permeate.

In illustrative embodiments, the one or more components may comprise phosphorous or derivatives thereof. Passing the MBR permeate through the electro-chemical cell component may comprise subjecting the MBR permeate to a predefined amperage within the electro-chemical cell component sufficient to remove the phosphorus or derivatives thereof based on the anode type being used.

In other illustrative embodiments, passing the MBR permeate through the electro-chemical cell component comprises subjecting the MBR permeate to an electro-oxidation process and an electrocoagulation process to produce a precipitate from the MBR permeate.

In yet other illustrative embodiments, the method includes passing the exudate through a tertiary membrane component to generate an effluent for discharge into an environment. The effluent may comprise phosphorus concentrations less than <0.05 mg/L. The one or more components may comprise nitrogen or derivatives thereof.

In other illustrative embodiment, the electro-chemical cell component comprises a sacrificial anode-catheter pair and a non-sacrificial anode catheter-pair.

In another illustrative embodiment, a method for treating wastewater comprises passing wastewater through a membrane bio-reactor (MBR) component to remove at least portions of phosphorous or derivatives thereof from the wastewater and generate a permeate, passing the MBR permeate through an electro-chemical cell component to remove at least remaining portions of the of phosphorous or derivatives thereof and generate an exudate, and passing the exudate through a tertiary membrane component to produce an effluent for discharge into an environment. The generated effluent may comprise phosphorus concentrations less than <0.05 mg/liter.

In another illustrative embodiment, a system for treating wastewater comprises a pretreatment component for receiving wastewater and being configured to remove at least portions of one or more contaminants from the wastewater and generate a permeate and an electro-chemical cell component in line with the pretreatment component for receiving the permeate and being configured to remove at least remaining portions of the one or more contaminants and generate an exudate. The pretreatment component may comprise a membrane bioreactor (MBR) component. The one or more contaminants comprises phosphorous or derivatives thereof.

Other advantages of the wastewater treatment system of the present disclosure system will be appreciated from the following description.

### BRIEF DESCRIPTION OF THE DRAWINGS

Various embodiments of the present disclosure are described hereinbelow with references to the drawings, wherein:

FIG. 1 is a diagram of a system for treatment of wastewater illustrating a membrane bio reactor component, an electro-chemical cell component and a tertiary membrane component of the system in accordance with one or more illustrative embodiments of the present disclosure.

FIG. 2 is a diagram of associated components of the membrane bio reactor component for use with the system for treatment of wastewater of FIG. 1 in accordance with one or more illustrative embodiments of the present disclosure.

FIGS. 3A and 3B are views illustrating nitrification and denitrification processes associated with the system for treatment of wastewater in accordance with one or more illustrative embodiments of the present disclosure.

FIGS. 4, 5 and 6 are First, Second and Third Tables respectively illustrating details of results of contaminant removal in accordance with the system of FIGS. 1-3B.

### DETAILED DESCRIPTION

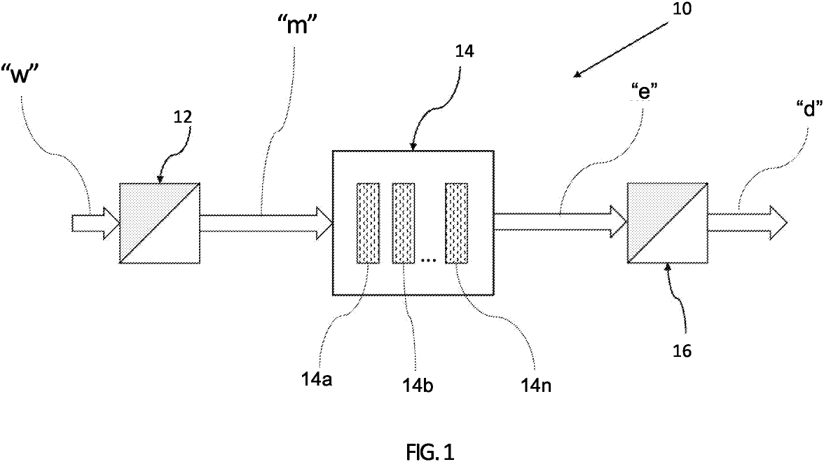

In one illustrative embodiment of the present disclosure, a system for treating water and/or wastewater is capable of producing a high-quality effluent suitable for discharge to receiver streams where the loadings of contaminants, for example, and without limitation, phosphorous, are of paramount concern, and which meets standards established by governing bodies. In one illustrative embodiment depicted in FIG. 1, the treatment system or process 10 includes a membrane bio reactor (MBR) component 12, an electro-chemical cell component 14 comprising, for example, one or more electro-chemical cells 14a, 14b ...14n in series, and a tertiary membrane component 16. In general, the MBR component 12 essentially functions by combining activated sludge processes with membrane filtration to wastewater “w” to generate a high quality MBR permeate “m” free of suspended solids, reduced bacterial and viral content and other contaminants. More specifically, the wastewater “w” is passed through and/or introduced into the MBR component 12, to pretreat the wastewater “w” and remove a range of at least a portion of the contaminants including, but not limited to nitrogen, phosphorous, bacteria, bio-chemical oxygen demand, and total suspended solids. The MBR component 12 utilizes one or more microfiltration and ultrafiltration processes integrated with a biological process such as a suspended growth bioreactor to remove solids developed during the biological process, to generate a relatively clear and a reduced pathogen MBR permeate “m.”

In general, the MBR component 12 is compact and functions in association with a high concentration of activated sludge reducing the reactor size and eliminating the need for secondary clarifiers and sand filters. The MBR treatment component 12 is operable in small space constraints requiring a small footprint. The MBR treatment component 12 may be an internal/submerged unit when immersed in a biological reactor or an external/side stream unit when located outside of a biological reactor.

Moreover, the MBR treatment component 12 provides better effluent quality, smaller space requirements, and ease of automation relative to conventional biological systems including, for example, a conventional activated sludge (CAS) system. Specifically, the MBR treatment component 12 operates at higher volumetric loading rates which result in lower hydraulic retention times. The low retention times mean that less space is required compared to a conventional system. The MBR treatment component 12 may be operated with longer solids residence times (SRTs), which results in lower sludge production; but this is not a requirement, and more conventional SRTs have been used. The MBR permeate “m” contains low concentrations of bacteria, total suspended solids (TSS) and biochemical oxygen demand (BOD). This facilitates high-level disinfection. In some illustrative embodiments, the MBR permeate “m” may be readily discharged to surface streams or can be sold for reuse, such as irrigation.

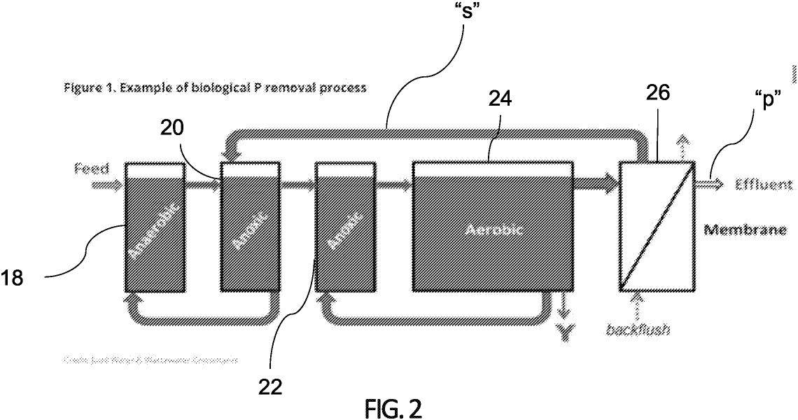

FIG. 2 illustrates the MBR treatment component 12 in association with its various phases or zones to treat wastewater “w.” The zones include, in sequence, an anaerobic zone 18, a first anoxic zone 20, a second anoxic zone 22 and an aerobic zone 24 and one or more membranes 26 (e.g., multi-tube membranes). The one or more membranes 26 delivers the permeate “p” which is extracted under pressure. Sludge “s” or the return take is delivered back to the anoxic zone of the process. Waste sludge “Y” from the process is released to maintain the concentration at an appropriate level.

Anaerobic, anoxic and aerobic systems are forms of biological treatment that use microorganisms to break down and remove organic contaminants from wastewater. While they all rely on a process of microbial decomposition to treat wastewater, the key difference between anaerobic/anoxic and aerobic treatment is that aerobic systems require oxygen, while anaerobic/anoxic systems do not. This is a function of the types of microbes used in each type of system.

Anaerobic digestion is a process through which bacteria break down organic matter—such as animal manure, wastewater biosolids, and food wastes—in the absence of oxygen.

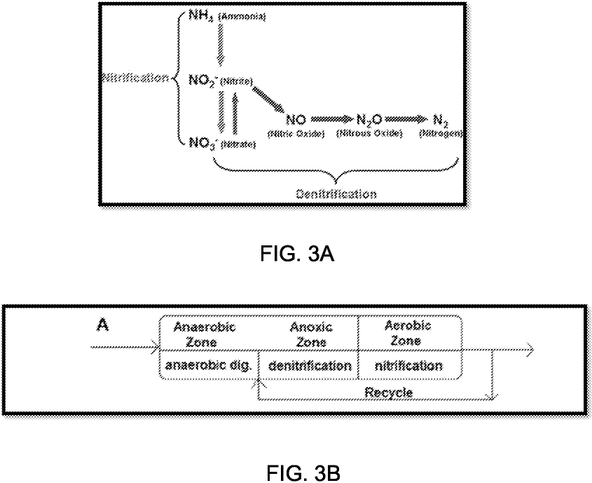

With reference to FIGS. 3A and 3B, nitrification, as performed in an aerobic process, is formally a two-step process; in the first step ammonia is oxidized to nitrite, and in the second step nitrite is oxidized to nitrate. Different microbes are responsible for each step in the marine environment. Denitrification, as performed in the anoxic process includes the deficiency or depletion of oxygen. The process by which the nitrate-nitrogen gets converted to molecular nitrogen gas in the absence of oxygen.

While anaerobic/anoxic and aerobic systems are capable of treating many of the same biological constituents, there are some differences that make each technology better suited for specific contaminants, concentration levels, temperatures, or other wastewater stream characteristics. In general, aerobic treatment systems are best suited for streams with relatively low BOD/COD, and are also used for removal of nitrogen and phosphorus. On the other hand, anaerobic systems are typically used for treatment of waste streams with high concentrations of organic contaminants, and for warm wastewater streams.

Anaerobic and aerobic systems are most often paired for treatment of streams with a high concentration of organic contaminants. For these setups, anaerobic treatment is used for initial reduction of organic contaminant levels, while aerobic treatment is used as a secondary polishing step to further reduce BOD and TSS. In some cases, the secondary aerobic treatment step is used to oxidize ammonia to form nitrate. In general, using both technologies together result in more efficient treatment than if an aerobic system were used alone, as well as more complete contaminant removal than if anaerobic treatment were used alone.

Although the MBR component 12 including the associated zones 18, 20, 22 and 24 and one or more membranes 26 are generally effective for removing most contaminants, this subsystem is deficient in eliminating phosphorous in accordance with municipal standards.

Phosphorus and its derivatives including phosphates etc. [hereinafter, collectively referred to as “phosphorous”) releases due to anthropogenic activity which promotes eutrophication in aquatic ecosystems. For example, the main sources of phosphorous entering rivers are sewage effluent and agricultural run-off with a substantial proportion being attributed to sewage discharges. This reality has resulted in tightening phosphorous discharge standards by governing bodies and increased pressure on the water industry to reduce phosphorous loads entering rivers, particularly, to ecologically sensitive locations. As such, targeted phosphorous removal has become increasingly common in large, urban wastewater treatment plants (hereinafter, referred to as “WWTPs”). However, sensitive watercourses also can be in more remote locations, receiving phosphorous discharges from smaller WWTPs. Further, wastewater from smaller communities is often treated less rigorously and the potential negative impacts of phosphorous release from small treatment works may be underestimated.

Wastewater which includes phosphorous can create severe water pollution problems for aquatic life because of its various contents. Water pollution by nutrients including phosphorous is a historical and ever-growing concern in developed and developing countries alike. On one hand phosphorus is an important nutrient that is critically needed for the normal functioning of ecosystems. Phosphorus is found as phosphate (P043) in nature and presents in derivatives as orthophosphate, polyphosphate and organic phosphate in water. Phosphorus compounds came from various sources, but agriculture and cattle are the main direct and indirect origins of its presence. On the other hand, phosphorous remains a critical environmental pollutant, it is one of the nutrients responsible for eutrophication of the receiving water bodies and subsequent deterioration of water quality. Eutrophication is a common environmental problem that arises in the interface between human activity and surface water. Environmental problems arise as the algae decays, consuming dissolved oxygen required for higher organisms and degrading general water quality.

In response to phosphorous or phosphate evolved problems, various methods have been used for its removal from wastewater including the aforedescribed biological methodology incorporating the MBR treatment component 12 with some or all of the various additional or ancillary zones 18, 20, 22, 24. Other methodologies include physical and chemical processes. Physical methods are too expensive. Phosphorous removal by chemical treatments is not optimal due to disadvantages including high maintenance cost, problems of sludge handling and its disposal, and neutralization of the effluent. In biological treatment such as the use of the MBR treatment component 12 described hereinabove, removal efficiency of phosphorous usually doesn’t exceed 30%.

Thus, in accordance with one illustrative embodiment of the present disclosure, the system 10 includes one or more features or components to enhance removal of phosphorous and its derivatives, compounds, etc., in addition to other contaminants, from wastewater. The one or more features is inclusive of at least the electro-chemical cell component 14 which is positioned directly, or indirectly, in sequence with the MBR treatment component 12 to receive the MBR permeate “m” detailed in FIG. 1 (e.g., effluent “p” of FIG. 2). The electro-chemical cell component 14 consists of a watertight housing, internal conductive metal plates commonly known as anodes and cathodes, and a DC power supply to induce an adjustable current. Moreover, the present disclosure contemplates that the use of the electro-chemical cell component 14 in combination with the MBR treatment component 12 further reduces residual contaminants including phosphorous, compounds or derivative thereof found in the MBR permeate “m” by subjecting the MBR permeate “m” to one or more electrochemical processes in the electro-chemical cell component 14 to produce an effluent “e” substantially free from phosphorous, phosphates and/or its derivatives.

In illustrative embodiments, the electro-chemical cell component 14 comprises one or more electro-chemical cells 14a, 14b...14n arranged in series where the letter “n” represents a number of electro-chemical cells. In one application, the MBR permeate “m” is passed through the electro-chemical cell component 14 and subjected to at least a two-step electro-chemical process(es) within the series of electro-chemical cells 14a, 14b...14n. In a first step, for example in electro-chemical cell 14a, an electro-oxidation process is applied using non-sacrificial anodes fabricated, for example, of titanium such as a Magneli-phase titanium suboxide (M-TiSO) anode to oxidize residual contaminants such as nitrogen or ammonia. In a second step, for example in electro-chemical cell 14b...14n, the MBR permeate “m” is subjected to an electro-coagulation process using magnesium, aluminum or iron sacrificial anodes to create and coagulant non-soluble colloidal particles.

In addition, as a further feature of the present invention, the effluent “e” produced or generated by the electro-chemical cell component 14 optionally may be passed through the tertiary membrane component 16 to capture and remove any remaining residual contaminants and generate a discharge flow “d” suitable for discharge into the environment. The tertiary membrane component 16 may be used in applications that require lower concentrations of effluent TSS or associated contaminants than other tertiary filtration methods such as sand or cloth filters are capable of providing.

Thus, the present disclosure combines the treatment capabilities of the MBR treatment component 12, the electro-chemical cell component 14 and, optionally, the tertiary membrane component 16, to significantly improve wastewater quality, to produce a discharge “d” containing ultra-low levels of contaminants, including but not limited to phosphorous, and nitrates, ammonia, etc., at a far more economical rate.

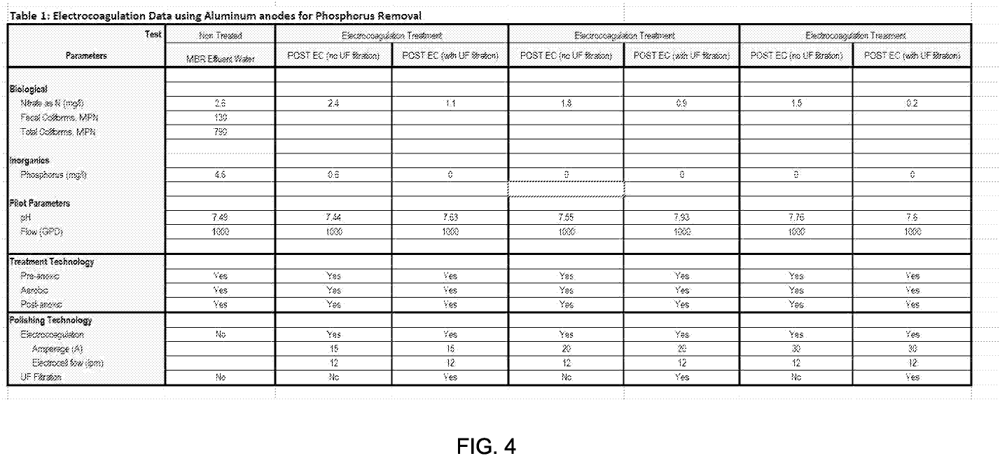

Tables 1, 2 and 3 of FIGS. 4, 5 and 6 respectively illustrate a comparison of wastewater treated by the MBR treatment component 12 (referred to as “MBR Effluent Treated Water” in the Tables) and wastewater treated by the MBR component 12 and the electrochemical cell component 14 (referred to as “EC or EO Treated Water” in the Tables) at various amperages and LPM flows.

Table 1 of FIG. 3 quantifies the amount of nitrates and phosphorus remaining in the sampled “MBR Effluent Water” for various amperages including 15, 20 and 30 amps of the electrochemical cell component 14A, 14B..14N at a flow of 12 liters per minutes through the cell. As appreciated, the “EC Effluent” has a substantially reduced level of phosphorus, for example, decreasing to zero, upon exposure to higher amperages of twenty (20) and thirty (30) amps. Also, passing the “EC Effluent Water” through the tertiary filter component 16 reduces the level of phosphorus to zero at fifteen (15) amps. The amount of nitrates also decreased with increased amperage exposure and was substantially reduced when passed through the tertiary membrane component 16.

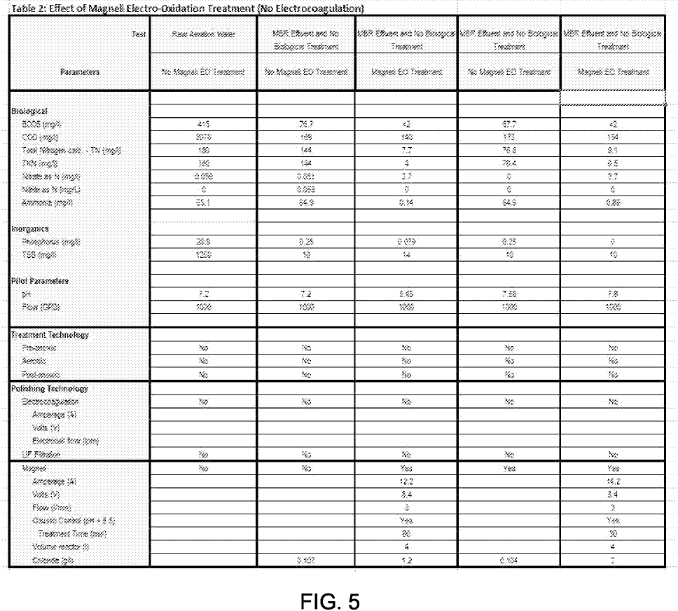

Table 2 of FIG. 5 quantifies the amount of nitrates and phosphorus remaining in the sampled “Raw Aeration Water” for various amperages including 12.2 amperages and 14.2 amperages for 60 and 30 minute treatment times, respectively, of the electro-oxidation cell component 14a at a flow of 3 liters per minute. As detailed in Table 2, the “EO Treated Water” has a substantially reduced level of phosphorus, for example, decreasing to zero, upon exposure to higher amperages. The amount of nitrates, COD, BOD TKN, ammonia and TSS also decreased with increased amperage exposure.

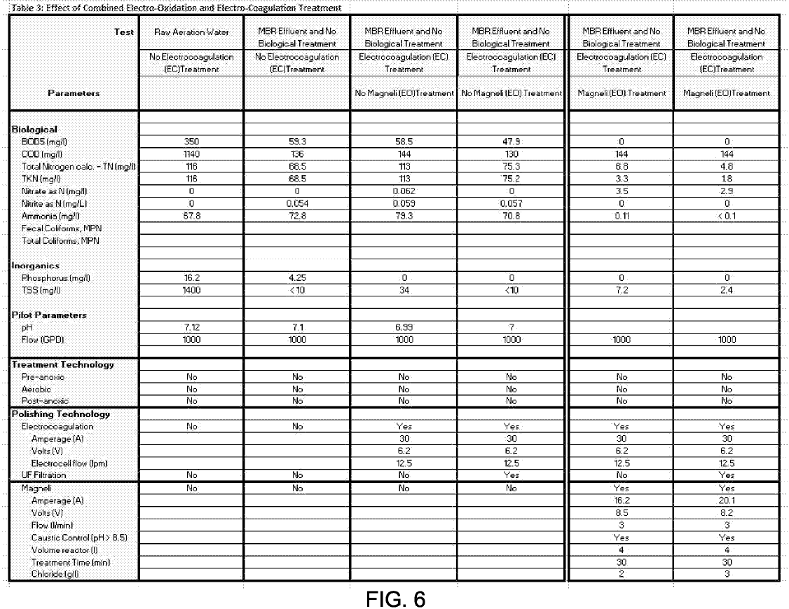

Table 3 of FIG. 6 quantifies the amount of nitrates and phosphorus when both electro-oxidation (EO) and electrocoagulation (EC) are applied in sequence. The joint application substantially reduces the levels of nitrates, COD, BOD TKN, ammonia and TSS. This reduction is further reduced when the treated water is passed through the tertiary membrane component. The joint use of EO and EC results in better treatment at lower power consumption.

The data in Tables 1, 2 and 3 clearly depicts that the application of an electrochemical cell process reduces the residual phosphorus levels to approach and/or achieve 0.0 mg/liter, in particular, at higher amperage and with UF filtration. The process is also economical costing due to its low DC voltage (2-8 volts) and amperage.

In other exemplative embodiments, it is contemplated that the electro-chemical cell component 14 may remove remaining total suspended solids (TSS), heavy metals, emulsified oils (FOG), bacteria, viruses, biological oxygen demand (BOD), chemical oxygen demand (COD), ammonia, nitrites, nitrates, polyfluoroalkyl substances (PFAS), pharmaceuticals, and other contaminants of interest such as micro toxins from algae. The electro-chemical cell component 14 includes a watertight housing, internal conductive metal plates commonly known as anodes and cathodes, and a DC power supply to induce an adjustable current. Optionally, concentrated oxygen (50% and higher) or ozone may be added to the MBR permeate to enhance residual contaminant removal by the electro-chemical cell component 14. Moreover, the use of the MBR treatment component 12 for pre-treatment permits the electro-cell component 14 to focus on a specific range of contaminants, particularly, phosphorous, which results in treatment efficiencies.

In other illustrative embodiments, the pretreatment component may include a moving bed biofilm reactor (MBBR) treatment process, a sequencing batch reactor process (SBR) or a conventional activated sludge (CAS) process and/or combinations thereof in lieu or in addition to the MBR treatment component 12 described hereinabove.

Although the illustrative embodiments of the present disclosure have been described herein with reference to the accompanying drawings, the above description, disclosure, and figures should not be construed as limiting, but merely as exemplifications of particular embodiments. It is to be understood, therefore, that the disclosure is not limited to those precise embodiments, and that various other changes and modifications may be effected therein by one skilled in the art without departing from the scope or spirit of the disclosure.

What is claimed is:

1. A method for treating wastewater comprising:
passing wastewater through a pretreatment component to remove at least portions of one or more contaminants from the wastewater and generate a permeate; and
passing the permeate through an electro-chemical cell component to remove at least remaining portions of the one or more contaminants and generate an exudate.

2. The method according to claim 1 wherein passing wastewater comprises passing the wastewater through a membrane bioreactor (MBR) component to produce an MBR permeate.

3. The method according to claim 2 wherein the one or more components comprises phosphorous or derivatives thereof.

4. The method according to claim 3 wherein passing the MBR permeate through the electro-chemical cell component comprises subjecting the MBR permeate to a predefined amperage within the electro-chemical cell component.

5. The method according to claim 4 wherein the predefined amperage ranges from ten (10) to thirty (30) amperages.

6. The method according to claim 3 wherein passing the MBR permeate through the electro-chemical cell component comprises subjecting the MBR permeate to an electro-oxidation process and an electrocoagulation process to produce a precipitate from the MBR permeate.

7. The method according to claim 3 including passing the exudate through a tertiary membrane component to generate an effluent for discharge into an environment.

8. The method according to claim 7 wherein the effluent comprises phosphorus concentrations less than 0.05 mg/liter.

9. The method according to claim 1 wherein the electro-chemical cell component comprises a sacrificial anode-catheter pair and a non-sacrificial anode catheter-pair.

10. The method according to claim 1 wherein the one or more components comprises nitrogen or derivatives thereof.

11. A method for treating wastewater comprising:
passing wastewater through a membrane bioreactor (MBR) component to remove at least portions of phosphorous or derivatives thereof from the wastewater and generate a permeate;
passing the MBR permeate through an electro-chemical cell component to remove at least remaining portions of the of phosphorous or derivatives thereof and generate an exudate; and
passing the exudate through a tertiary membrane component to produce an effluent for discharge into an environment.

12. The method according to claim 11 wherein the effluent comprises phosphorus concentrations less than 0.05 mg/liter.

13. A system for treating wastewater comprising:
a pretreatment component for receiving wastewater and being configured to remove at least portions of one or more contaminants from the wastewater and generate a permeate; and
an electro-chemical cell component in line with the pretreatment component for receiving the permeate and being configured to remove at least remaining portions of the one or more contaminants and generate an exudate.

14. The system according to claim 13 wherein the pretreatment component comprises a membrane bioreactor (MBR) component.

15. The system according to claim 14 wherein the one or more contaminants comprises phosphorous or derivatives thereof.
